(19) United States
(12) Patent Application Publication
(10) Pub. No.: US 2026/0141844 A1
(43) Pub. Date: May 21, 2026

(54) Display Panel, Display Apparatus, And Electronic Apparatus Including The Same

(71) Applicant: Samsung Display Co., Ltd., Yongin-si (KR)

(72) Inventors: Hyang-A Park, Yongin-si (KR); Seoyoung Lim, Yongin-si (KR); Bokwang Song, Yongin-si (KR)

(73) Assignee: Samsung Display Co., Ltd., Yongin-si (KR)

(21) Appl. No.: 19/341,137

(22) Filed: Sep. 26, 2025

(30) Foreign Application Priority Data
Nov. 21, 2024 (KR) 10-2024-0167017

(51) Int. Cl. G09G 3/32

(52) U.S. Cl. CPC G09G 3/32; G09G 2300/0819; G09G 2310/0267; G09G 2310/0275; G09G 2310/08; G09G 2320/0233; G09G 2320/0242; G09G 2320/041; G09G 2330/021; G09G 2360/14

(57) ABSTRACT

A display panel includes a pixel circuit and a sensing circuit. The pixel circuit includes a light emitting element, a driving switching element configured to transmit a driving current to the light emitting element. A writing switching element is configured to apply a data voltage to the driving switching element in response to a writing gate signal. The sensing circuit includes a first sensing switching element that includes i a first electrode configured to receive a first power voltage and a second electrode connected to a fourth node and a second sensing switching element. A control electrode is configured to receive the writing gate signal. A first electrode is connected to the fourth node and a second electrode is connected to a readout line.

### PRIORITY STATEMENT

This application claims priority under 35 U.S.C. § 119 to Korean Patent Application No. 10-2024-0167017, filed on Nov. 21, 2024 in the Korean Intellectual Property Office KIPO, the contents of which are herein incorporated by reference in their entireties.

### BACKGROUND

### 1. Technical Field

Examples of the present inventive concept relate to a display panel, a display apparatus including the display panel and an electronic apparatus including the display apparatus. More particularly, examples of the present inventive concept relate to a display panel enhancing a display quality, a display apparatus including the display panel and an electronic apparatus including the display apparatus.

### 2. Description of Related Art

Generally, a display apparatus includes a display panel and a display panel driver. The display panel includes a plurality of gate lines, a plurality of data lines, a plurality of emission lines and a plurality of pixels. The display panel driver includes a gate driver, a data driver, an emission driver, and a driving controller. The gate driver outputs gate signals to the gate lines. The data driver outputs data voltages to the data lines. The emission driver outputs emission signals to the emission lines. The driving controller controls an operation of the gate driver, an operation of the data driver and an operation of the emission driver.

Characteristics of a driving switching element of a pixel of the display panel may be shifted according to a temperature so that a luminance and color coordinates of a display image may be changed according to the temperature. Although the change of the luminance and the color coordinates of the display image may be alleviated by enhancing the characteristics of the driving switching element, it is difficult to prevent an influence due to variations.

While use of the above-mentioned and other similar varieties of display devices is generally desirable, existing devices may suffer from inadequate change of the luminance and the color coordinates of the display image. Accordingly, a need exists for display devices with better reliability.

### SUMMARY

Some examples of the present inventive concept provide a display panel enhancing a display quality by sensing temperatures for positions of the display panel in real time using a sensing circuit including a first sensing switching element and a second sensing switching element and compensating a data voltage using the temperatures for the positions.

Examples of the present inventive concept also provide a display apparatus including the display panel.

Examples of the present inventive concept also provide an electronic apparatus including the display apparatus.

In an example of a display panel according to the present inventive concept, the display panel includes a pixel circuit and a sensing circuit. The pixel circuit includes a light emitting element, a driving switching element configured to transmit a driving current to the light emitting element, a writing switching element configured to apply a data voltage to the driving switching element in response to a writing gate signal. The sensing circuit includes a first sensing switching element including a first electrode configured to receive a first power voltage and a second electrode connected to a fourth node and a second sensing switching element including a control electrode configured to receive the writing gate signal, a first electrode connected to the fourth node and a second electrode connected to a readout line.

In an example, a control electrode of the first sensing switching element may be configured to receive a monitoring voltage. The monitoring voltage may be determined by subtracting a target threshold voltage of the driving switching element from the data voltage.

In an example, the sensing circuit may include a third sensing switching element including a control electrode configured to receive a sensing gate signal, a first electrode configured to receive a reset voltage or a monitoring voltage and a second electrode connected to a control electrode of the first sensing switching element and a photo diode including a first electrode connected to the control electrode of the first sensing switching element and a second electrode configured to receive a second power voltage.

In an example, in a first sensing mode, an active level of the sensing gate signal may be maintained, the monitoring voltage may be applied to the first electrode of the third sensing switching element and the first power voltage may be applied to the first electrode of the first sensing switching element. In a second sensing mode, the reset voltage may be applied to the first electrode of the third sensing switching element and a second initialization voltage may be applied to the first electrode of the first sensing switching element.

In an example, the pixel circuit may further include a compensation switching element including a control electrode configured to receive a compensation gate signal, a first electrode connected to a control electrode of the driving switching element and a second electrode connected to a second electrode of the driving switching element and a data initialization switching element including a control electrode configured to receive a data initialization gate signal, a first electrode configured to receive a first initialization voltage and a second electrode connected to the control electrode of the driving switching element.

In an example, the driving switching element and the writing switching element may be P-type transistors. The compensation switching element and the data initialization switching element may be N-type transistors.

In an example, the driving switching element, the writing switching element, the compensation switching element and the data initialization switching element may be P-type transistors.

In an example, the pixel circuit may further include a light emitting element initialization switching element including a control electrode configured to receive a bias gate signal, a first electrode configured to receive a second initialization voltage and a second electrode connected to an anode electrode of the light emitting element.

In an example, the pixel circuit may further include a bias switching element including a control electrode configured to receive the bias gate signal, a first electrode configured to receive a bias voltage and a second electrode connected to a first electrode of the driving switching element.

In an example, the driving switching element may include a control electrode. The driving switching element control electrode is connected to a first node, a driving switching element first electrode connected to a second node and a driving switching element second electrode connected to a third node. The writing switching element may include a writing switching element control electrode configured to receive the writing gate signal, a writing switching element first electrode configured to receive the data voltage and a writing switching element second electrode connected to the second node. The pixel circuit may further include a compensation switching element including a compensation switching element control electrode configured to receive a compensation gate signal, a compensation switching element first electrode connected to the first node and a compensation switching element second electrode connected to the third node. A data initialization switching element may include a data initialization switching element control electrode configured to receive a data initialization gate signal, a data initialization switching element first electrode configured to receive a first initialization voltage and a data initialization switching element second electrode connected to the first node. A first emission switching element nay include a first emission switching element control electrode configured to receive an emission signal, a first emission switching element first electrode configured to receive a first power voltage and a first emission switching element second electrode connected to the second node. A second emission switching element may include a second emission switching element control electrode configured to receive the emission signal, a second emission switching element first electrode connected to the third node and a second emission switching element second electrode connected to an anode electrode of the light emitting element. A light emitting element initialization switching element may include a light emitting element initialization switching element control electrode configured to receive a bias gate signal, a light emitting element initialization switching element first electrode configured to receive a second initialization voltage and a light emitting element initialization switching element second electrode connected to the anode electrode of the light emitting element. A bias switching element may include a bias switching element control electrode configured to receive the bias gate signal, a bias switching element first electrode configured to receive a bias voltage and a bias switching element second electrode connected to the second node. A first capacitor may include a first capacitor, first electrode configured to receive the first power voltage and a first capacitor second electrode connected to the first node.

In an example, the emission signal may have an inactive level in a first period, the data initialization gate signal may have an inactive level in the first period, the compensation gate signal may have an active pulse in the first period, the writing gate signal may have an inactive level in the first period and the bias gate signal may have an active pulse in the first period. The emission signal may have the inactive level in a second period subsequent to the first period, the data initialization gate signal may have an active level in the second period, the compensation gate signal may have an inactive level in the second period, the writing gate signal may have the inactive level in the second period and the bias gate signal may have an inactive level in the second period. The emission signal may have the inactive level in a third period subsequent to the second period, the data initialization gate signal may have the inactive level in the third period, the compensation gate signal may have an active level in the third period, the writing gate signal may have an active pulse in the third period and the bias gate signal may have the inactive level in the third period. The emission signal may have the inactive level in a fifth period subsequent to the third period, the data initialization gate signal may have the inactive level in the fifth period, the compensation gate signal may have the inactive level in the fifth period, the writing gate signal may have the inactive level in the fifth period and the bias gate signal may have the inactive level in the fifth period.

In an example, the emission signal may have the inactive level in a fourth period between the third period and the fifth period, the data initialization gate signal may have the inactive level in the fourth period, the compensation gate signal may have the active level in the fourth period, the writing gate signal may have the inactive level in the fourth period and the bias gate signal may have the inactive level in the fourth period.

In an example, a ratio between the number of the pixel circuits and the number of the sensing circuits may be 1:1 in the display panel. A first pixel row of the display panel may include a first pixel circuit, a first sensing circuit, a second pixel circuit, a second sensing circuit, a third pixel circuit, a third sensing circuit, a fourth pixel circuit and a fourth sensing circuit which are sequentially disposed.

In an example, a ratio between the number of the pixel circuits and the number of the sensing circuits may be 4:1 in the display panel. A first pixel row of the display panel may include a first pixel circuit, a second pixel circuit, a first sensing circuit, a third pixel circuit, a fourth pixel circuit, a fifth pixel circuit, a sixth pixel circuit, a second sensing circuit, a seventh pixel circuit and an eighth pixel circuit which are sequentially disposed.

In an example, a ratio between the number of the pixel circuits and the number of the sensing circuits may be 8:1 in the display panel. A first pixel row of the display panel may include a first pixel circuit, a second pixel circuit, a third pixel circuit, a fourth pixel circuit, a first sensing circuit, a fifth pixel circuit, a sixth pixel circuit, a seventh pixel circuit and an eighth pixel circuit which are sequentially disposed.

In an example of a display apparatus according to the present inventive concept, the display apparatus includes a display panel, a gate driver, a data driver, and a sensing driver. The display panel includes a pixel circuit and a sensing circuit. The pixel circuit includes a light emitting element, a driving switching element configured to transmit a driving current to the light emitting element, a writing switching element configured to apply a data voltage to the driving switching element in response to a writing gate signal. The sensing circuit includes a first sensing switching element including a first electrode configured to receive a first power voltage and a second electrode connected to a fourth node and a second sensing switching element including a control electrode configured to receive the writing gate signal, a first electrode connected to the fourth node and a second electrode connected to a readout line. The gate driver is configured to apply a writing gate signal to the pixel circuit and the sensing circuit. The data driver is configured to apply the data voltage to the pixel circuit. The sensing driver is connected to the readout line.

In an example, the data driver and the sensing driver may be integratedly formed.

In an example, the sensing driver may be configured to apply a monitoring voltage to a control electrode of the first sensing switching element. The sensing driver may be configured to receive a sensed current through a readout line while changing the monitoring voltage. The sensing driver or the driving controller may be configured to determine temperatures for positions of the display panel based on the sensed current.

In an example, the driving controller may be configured to compensate a data signal based on the temperatures for the positions. The data driver may be configured to generate the data voltage based on the compensated data signal and to apply the data voltage to the pixel circuit.

In an example of a method of driving a display apparatus according to the present inventive concept, the method includes determining a voltage-current correlation of a first sensing switching element according to a first temperature, a second temperature and a third temperature using a sensing circuit including the first sensing switching element including a first electrode configured to receive a first power voltage and a second electrode connected to a fourth node and a second sensing switching element including a control electrode configured to receive a writing gate signal, a first electrode connected to the fourth node and a second electrode connected to a readout line, determining a voltage-luminance correlation of a driving switching element and a light emitting element according to the first temperature, the second temperature and the third temperature using a pixel circuit including the light emitting element, the driving switching element configured to transmit a driving current to the light emitting element, a writing switching element configured to apply a data voltage to the driving switching element in response to the writing gate signal, matching the voltage-current correlation and the voltage-luminance correlation according to the first temperature, the second temperature and the third temperature, receiving a sensed current through the readout line while changing a monitoring voltage applied to a control electrode of the first sensing switching element and determine temperatures for positions of the display panel based on the sensed current, compensating the data signal based on the temperatures for the positions and generating the data voltage based on the compensated data signal.

In an example of an electronic apparatus according to the present inventive concept, the electronic apparatus includes a display panel, a gate driver, a data driver, a driving controller, and a processor. The display panel includes a pixel circuit and a sensing circuit. The pixel circuit includes a light emitting element, a driving switching element configured to transmit a driving current to the light emitting element, a writing switching element configured to apply a data voltage to the driving switching element in response to a writing gate signal. The sensing circuit includes a first sensing switching element including a first electrode configured to receive a first power voltage and a second electrode connected to a fourth node and a second sensing switching element including a control electrode configured to receive the writing gate signal, a first electrode connected to the fourth node and a second electrode connected to a readout line. The gate driver is configured to apply a writing gate signal to the pixel circuit and the sensing circuit. The data driver is configured to apply the data voltage to the pixel circuit. The driving controller is configured to control the gate driver and the data driver. The processor is configured to output input image data and an input control signal to the driving controller.

According to the display panel, the display apparatus includes the display panel and the electronic apparatus including the display apparatus, the display panel includes the sensing circuit including the first sensing switching element and the second sensing switching element. The display apparatus may sense the temperatures for the positions of the display panel in real time using the sensing circuit and compensate the data voltage using the temperatures for the positions. Thus, the display quality of the display panel may be enhanced.

### BRIEF DESCRIPTION OF THE DRAWINGS

The above and other features and advantages of the present inventive concept will become more apparent by describing in detailed examples thereof with reference to the accompanying drawings, in which:

FIG. 1 is a block diagram illustrating a display apparatus according to an example of the present inventive concept;

FIG. 2A is a diagram illustrating an example of a display panel of FIG. 1;

FIG. 2B is a diagram illustrating an example of the display panel of FIG. 1;

FIG. 2C is a diagram illustrating an example of the display panel of FIG. 1;

FIG. 3 is a circuit diagram illustrating a pixel circuit and a sensing circuit of the display panel of FIG. 1;

FIG. 4 is a timing diagram illustrating input signals applied to the pixel circuit and the sensing circuit of FIG. 3;

FIG. 5 is a diagram illustrating a voltage-current curve of a first sensing switching element of FIG. 3 according to a first temperature, a second temperature and a third temperature;

FIG. 6 is a diagram illustrating a voltage-current curve of a driving switching element and a light emitting element of FIG. 3 according to the first temperature, the second temperature and the third temperature;

FIG. 7 is a diagram illustrating temperature sensing using the sensing circuit of FIG. 3;

FIG. 8 is a diagram illustrating data compensation of the pixel circuit of FIG. 3 based on the temperature sensing of FIG. 7;

FIG. 9 is a circuit diagram illustrating a pixel circuit and a sensing circuit of a display panel according to an example of the present inventive concept;

FIG. 10 is a circuit diagram illustrating a pixel circuit and a sensing circuit of a display panel according to an example of the present inventive concept;

FIG. 11 is a circuit diagram illustrating a pixel circuit and a sensing circuit of a display panel according to an example of the present inventive concept;

FIG. 12 is a circuit diagram illustrating a pixel circuit and a sensing circuit of a display panel according to an example of the present inventive concept;

FIG. 13 is a block diagram illustrating a display apparatus according to an example of the present inventive concept;

FIG. 14 is a block diagram illustrating an electronic apparatus according to an example of the present inventive concept;

FIG. 15 is a diagram illustrating an example in which the electronic apparatus of FIG. 14 is implemented as a smartphone; and

FIG. 16 is a diagram illustrating an example in which the electronic apparatus of FIG. 14 is implemented as a monitor.

### DETAILED DESCRIPTION OF THE INVENTIVE CONCEPT

Hereinafter, the present inventive concept will be explained in detail with reference to the accompanying drawings.

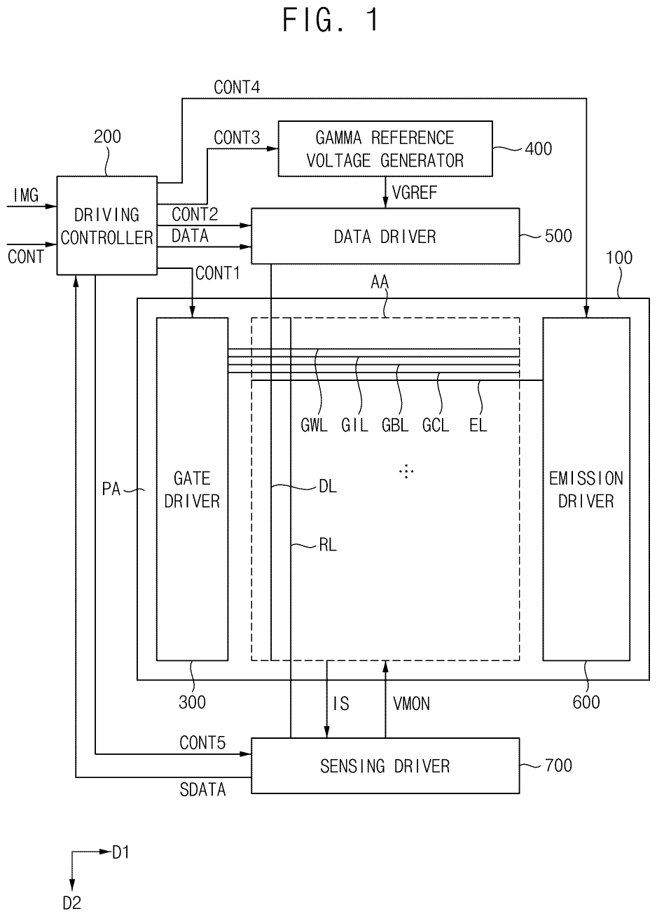

FIG. 1 is a block diagram illustrating a display apparatus according to an example of the present inventive concept.

Referring to FIG. 1, the display apparatus includes a display panel 100 and a display panel driver. The display panel driver includes a driving controller 200, a gate driver 300, a gamma reference voltage generator 400, a data driver 500 and an emission driver 600. The display panel driver may further include a sensing driver 700.

For example, the driving controller 200 and the data driver 500 may be integratedly formed. For example, the driving controller 200, the gamma reference voltage generator 400 and the data driver 500 may be integratedly formed. A driving module including at least the driving controller 200 and the data driver 500 which are integratedly formed may be referred to a timing controller embedded data driver (“TED”).

The display panel 100 has a display region AA on which an image is displayed and a peripheral region PA adjacent to the display region AA.

The display panel 100 includes a plurality of gate lines GWL, GIL, GBL and GCL, a plurality of data lines DL, a plurality of emission lines EL and a plurality of pixels electrically connected to the gate lines GWL, GIL, GBL and GCL, the data lines DL and the emission lines EL. The gate lines GWL, GIL, GBL and GCL may extend in a first direction D1, the data lines DL may extend in a second direction D2 crossing the first direction D1 and the emission lines EL may extend in the first direction D1.

The driving controller 200 may receive input image data IMG and an input control signal CONT from an external apparatus. For example, the driving controller 200 may receive the input image data IMG and the input control signal CONT from a processor. For example, the driving controller 200 may receive the input image data IMG and the input control signal CONT from a host. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and may output the third control signal CONT3 to the gamma reference voltage generator 400.

The driving controller 200 may generate the fourth control signal CONT4 for controlling an operation of the emission driver 600 based on the input control signal CONT, and may output the fourth control signal CONT4 to the emission driver 600.

The driving controller 200 may generate the fifth control signal CONT5 for controlling an operation of the sensing driver 700 based on the input control signal CONT, and may output the fifth control signal CONT5 to the sensing driver 700.

The gate driver 300 may generate gate signals driving the gate lines GWL, GIL, GBL and GCL in response to the first control signal CONT1 received from the driving controller 200. The gate driver 300 may output the gate signals to the gate lines GWL, GIL, GBL and GCL. For example, the gate driver 300 may be integrated on the peripheral region PA of the display panel 100. For example, the gate driver 300 may be mounted on the peripheral region PA of the display panel 100. For example, the gate driver 300 may apply a writing gate signal to a pixel circuit and a sensing circuit of the display panel 100.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF has a value corresponding to a level of the data signal DATA.

In an example, the gamma reference voltage generator 400 may be disposed in the driving controller 200, or in the data driver 500.

The data driver 500 may receive the second control signal CONT2 and the data signal DATA from the driving controller 200, and may receive the gamma reference voltages VGREF from the gamma reference voltage generator 400. The data driver 500 may convert the data signal DATA into data voltages having an analog type using the gamma reference voltages VGREF. The data driver 500 may output the data voltages to the data lines DL. For example, the data driver 500 may apply the data voltage to the pixel circuit of the display panel 100.

The emission driver 600 may generate emission signals to drive the emission lines EL in response to the fourth control signal CONT4 received from the driving controller 200. The emission driver 600 may output the emission signals to the emission lines EL. For example, the emission driver 600 may be integrated on the peripheral region PA of the display panel 100. For example, the emission driver 600 may be mounted on the peripheral region PA of the display panel 100. For example, the emission driver 600 may apply the emission signal to the pixel circuit of the display panel 100.

Although the gate driver 300 is disposed of at a first side of the display panel 100 and the emission driver 600 is disposed at a second side of the display panel 100 opposite to the first side in FIG. 1 for convenience of explanation, the present inventive concept may not be limited thereto. For example, both gate driver 300 and the emission driver 600 may be disposed of at the first side of the display panel 100. For example, both gate driver 300 and the emission driver 600 may be disposed of both sides of the display panel 100. For example, gate driver 300 and the emission driver 600 may be integratedly formed.

The sensing driver 700 may output a monitoring voltage VMON in response to the fifth control signal CONT5 received from the driving controller 200. For example, the sensing driver 700 may output the monitoring voltage VMON to the sensing circuit of the display panel 100.

The sensing driver 700 may receive a sensed current IS from the display panel 100. For example, the sensing driver 700 may receive the sensed current IS from the sensing circuit of the display panel 100. For example, the sensing driver 700 may receive the sensed current IS through a readout line RL while changing the monitoring voltage VMON.

The sensing driver 700 may determine temperatures SDATA for positions of the display panel 100 based on the sensed current IS. The sensing driver 700 may output the temperatures SDATA for the positions to the driving controller 200. Alternatively, the sensing driver 700 may output the sensed current IS to the driving controller 200. The driving controller 200 may determine the temperatures for the positions based on the sensed current IS.

The driving controller 200 may compensate for the data signal DATA based on the temperatures for the positions.

The data driver 500 may generate the data voltage based on the compensated data signal DATA and may apply the data voltage to the pixel circuit.

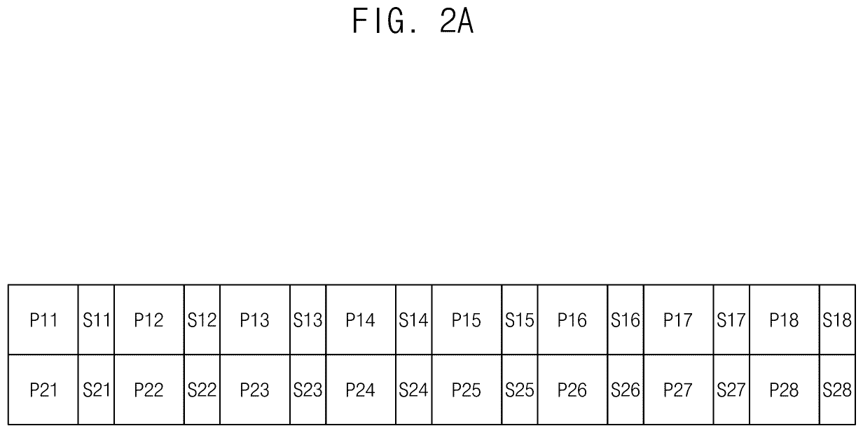

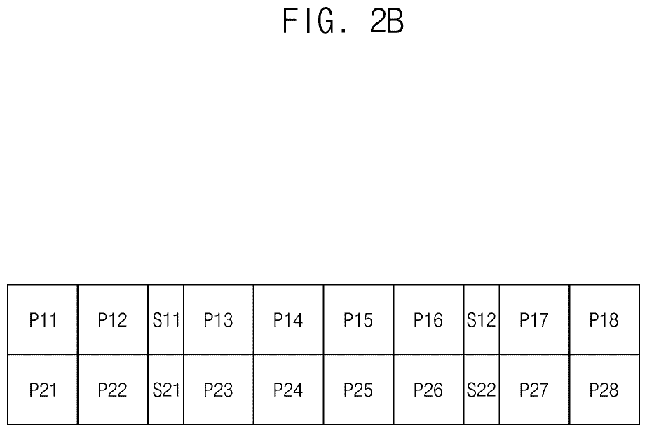

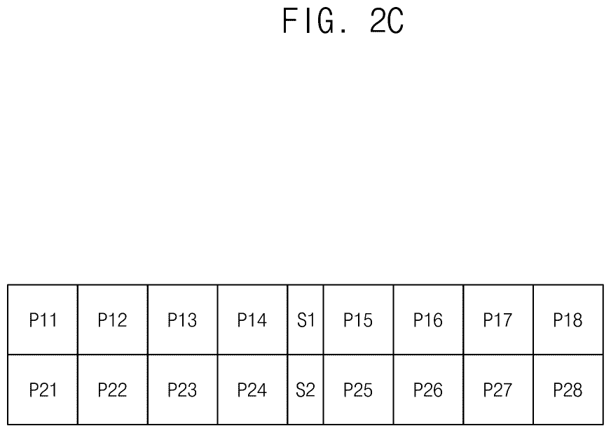

FIG. 2A is a diagram illustrating an example of the display panel 100 of FIG. 1.

Referring to FIGS. 1 to 2A, the display panel 100 may include the pixel circuit and the sensing circuit.

For example, a ratio between the number of the pixel circuits and the number of the sensing circuits may be 1:1 in the display panel 100.

A first pixel row of the display panel 100 may include a 1-1 pixel circuit P11, a 1-1 sensing circuit S11, a 1-2 pixel circuit P12, a 1-2 sensing circuit S12, a 1-3 pixel circuit P13, a 1-3 sensing circuit S13, a 1-4 pixel circuit P14 and a 1-4 sensing circuit S14 which are sequentially disposed. The first pixel row of the display panel 100 may further include a 1-5 pixel circuit P15, a 1-5 sensing circuit S15, a 1-6 pixel circuit P16, a 1-6 sensing circuit S16, a 1-7 pixel circuit P17, a 1-7 sensing circuit S17, a 1-8 pixel circuit P18 and a 1-8 sensing circuit S18 which are sequentially disposed.

For example, a temperature of the 1-1 pixel circuit P11 or a temperature of the 1-2 pixel circuit P12 which are adjacent to the 1-1 sensing circuit S11 may be predicted by a sensed current of the 1-1 sensing circuit S11.

A second pixel row of display panel 100 may include a 2-1 pixel circuit P21, a 2-1 sensing circuit S21, a 2-2 pixel circuit P22, a 2-2 sensing circuit S22, a 2-3 pixel circuit P23, a 2-3 sensing circuit S23, a 2-4 pixel circuit P24 and a 2-4 sensing circuit S24 which are sequentially disposed. The second pixel row of the display panel 100 may further include a 2-5 pixel circuit P25, a 2-5 sensing circuit S25, a 2-6 pixel circuit P26, a 2-6 sensing circuit S26, a 2-7 pixel circuit P27, a 2-7 sensing circuit S27, a 2-8 pixel circuit P28 and a 2-8 sensing circuit S28 which are sequentially disposed.

For example, a temperature of the 2-1 pixel circuit P21 or a temperature of the 2-2 pixel circuit P22 which are adjacent to the 2-1 sensing circuit S21 may be predicted by a sensed current of the 2-1 sensing circuit S21.

FIG. 2B is a diagram illustrating an example of display panel 100 of FIG. 1.

Referring to FIGS. 1 and 2B, the display panel 100 may include the pixel circuit and the sensing circuit.

For example, a ratio between the number of the pixel circuits and the number of the sensing circuits may be 4:1 in the display panel 100.

A first pixel row of the display panel 100 may include a 1-1 pixel circuit P11, a 1-2 pixel circuit P12, a 1-1 sensing circuit S11, a 1-3 pixel circuit P13, a 1-4 pixel circuit P14, a 1-5 pixel circuit P15, a 1-6 pixel circuit P16, a 1-2 sensing circuit S12, a 1-7 pixel circuit P17 and a 1-8 pixel circuit P18 which are sequentially disposed.

For example, a temperature of the 1-1 pixel circuit P11, a temperature of the 1-2 pixel circuit P12, a temperature of the 1-3 pixel circuit P13 and a temperature of the 1-4 pixel circuit P14 which are adjacent to the 1-1 sensing circuit S11 may be predicted by a sensed current of the 1-1 sensing circuit S11.

A second pixel row of the display panel 100 may include a 2-1 pixel circuit P21, a 2-2 pixel circuit P22, a 2-1 sensing circuit S21, a 2-3 pixel circuit P23, a 2-4 pixel circuit P24, a 2-5 pixel circuit P25, a 2-6 pixel circuit P26, a 2-2 sensing circuit S22, a 2-7 pixel circuit P27 and a 2-8 pixel circuit P28 which are sequentially disposed.

For example, a temperature of the 2-1 pixel circuit P21, a temperature of the 2-2 pixel circuit P22, a temperature of the 2-3 pixel circuit P23 and a temperature of the 2-4 pixel circuit P24 which are adjacent to the 2-1 sensing circuit S21 may be predicted by a sensed current of the 2-1 sensing circuit S21.

FIG. 2C is a diagram illustrating an example of the display panel 100 of FIG. 1.

Referring to FIGS. 1 and 2C, the display panel 100 may include the pixel circuit and the sensing circuit.

For example, a ratio between the number of the pixel circuits and the number of the sensing circuits may be 8:1 in the display panel 100.

A first pixel row of the display panel 100 may include a 1-1 pixel circuit P11, a 1-2 pixel circuit P12, a 1-3 pixel circuit P13, a 1-4 pixel circuit P14, a first sensing circuit S1, a 1-5 pixel circuit P15, a 1-6 pixel circuit P16, a 1-7 pixel circuit P17 and a 1-8 pixel circuit P18 which are sequentially disposed.

For example, a temperature of the 1-1 pixel circuit P11, a temperature of the 1-2 pixel circuit P12, a temperature of the 1-3 pixel circuit P13, a temperature of the 1-4 pixel circuit P14, a temperature of the 1-5 pixel circuit P15, a temperature of the 1-6 pixel circuit P16, a temperature of the 1-7 pixel circuit P17 and a temperature of the 1-8 pixel circuit P18 which are adjacent to the first sensing circuit S1 may be predicted by a sensed current of the first sensing circuit S1.

A second pixel row of the display panel 100 may include a 2-1 pixel circuit P21, a 2-2pixel circuit P22, a 2-3 pixel circuit P23, a 2-4 pixel circuit P24, a second sensing circuit S2, a 2-5 pixel circuit P25, a 2-6 pixel circuit P26, a 2-7 pixel circuit P27 and a 2-8 pixel circuit P28 which are sequentially disposed.

For example, a temperature of the 2-1 pixel circuit P21, a temperature of the 2-2 pixel circuit P22, a temperature of the 2-3 pixel circuit P23, a temperature of the 2-4 pixel circuit P24, a temperature of the 2-5 pixel circuit P25, a temperature of the 2-6 pixel circuit P26, a temperature of the 2-7 pixel circuit P27 and a temperature of the 2-8 pixel circuit P28 which are adjacent to the second sensing circuit S2 may be predicted by a sensed current of the second sensing circuit S2.

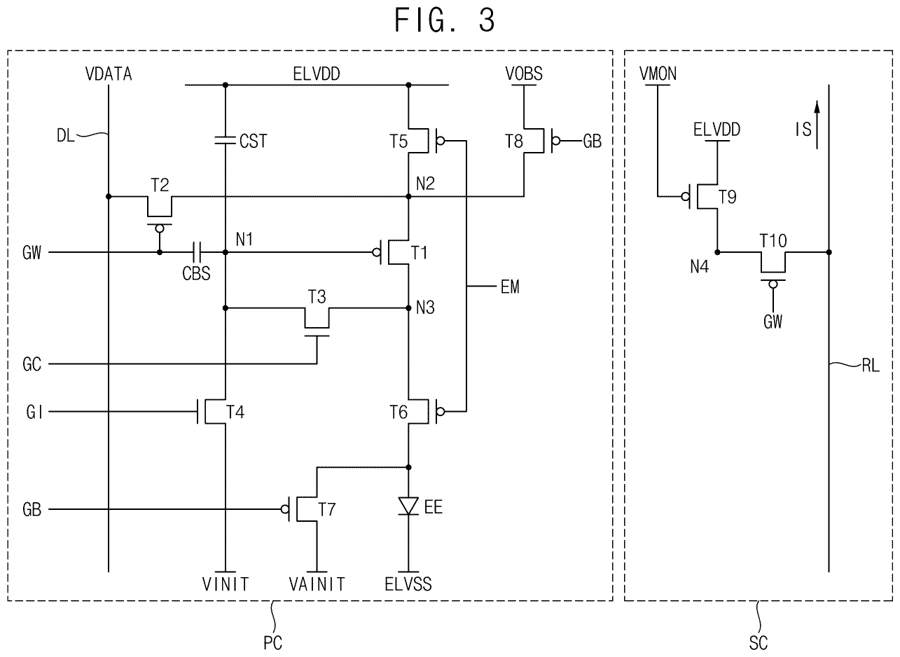

FIG. 3 is a circuit diagram illustrating the pixel circuit and the sensing circuit of the display panel 100 of FIG. 1.

Referring to FIGS. 1 to 3, the display panel 100 includes a plurality of pixel circuits PC and a plurality of sensing circuits SC.

The pixel circuit PC receives a writing gate signal GW, a compensation gate signal GC, a data initialization gate signal GI, a bias gate signal GB, the data voltage VDATA and the emission signal EM and displays an image according to a level of the data voltage VDATA.

The pixel circuit PC includes a light emitting element EE, a driving switching element T1 transmitting a driving current to the light emitting element EE, a writing switching element T2 applying the data voltage VDATA to the driving switching element T1 in response to the writing gate signal GW.

The sensing circuit SC receives the writing gate signal GW and the monitoring voltage VMON and outputs the sensed current IS.

The sensing circuit SC includes a first sensing switching element T9 including a first sensing switching element first electrode receiving a first power voltage ELVDD and a first sensing switching element second electrode connected to a fourth node N4 and a second sensing switching element T10 including a second sensing switching element control electrode receiving the writing gate signal GW, a second sensing switching element first electrode connected to the fourth node N4 and a second sensing switching element second electrode connected to the readout line RL.

A control electrode of the first sensing switching element T9 may receive the monitoring voltage VMON. For example, the sensing driver 700 may apply the monitoring voltage VMON to the control electrode of the first sensing switching element T9.

Herein, the monitoring voltage VMON may be determined by subtracting a target threshold voltage of the driving switching element T1 from the data voltage VDATA. Herein, the target threshold voltage of the driving switching element T1 may be a representative value of a threshold voltage of the driving switching element T1. Herein, the target threshold voltage of the driving switching element T1 may be an appropriate value of the threshold voltage of the driving switching element T1.

The data voltage VDATA may have a range from a data voltage for a minimum grayscale value to a data voltage for a maximum grayscale value. The monitoring voltage VMON may have a range from a subtraction of the target threshold voltage from the data voltage for the minimum grayscale value and a subtraction of the target threshold voltage from the data voltage for the maximum grayscale value.

In the present example, the pixel circuit PC may include a switching element of a first type and a switching element of a second type. For example, the switching element of the first type may be a polysilicon thin film transistor. For example, the switching element of the first type may be a low temperature polysilicon (“LTPS”) thin film transistor. For example, the switching element of the second type may be an oxide semiconductor thin film transistor. For example, the switching element of the first type may be a P-type transistor and the switching element of the second type may be an N-type transistor. Although some of switching elements of the pixel circuit PC are oxide semiconductor thin film transistors and other switching elements of the pixel circuit PC are polysilicon thin film transistors in the present example, the present inventive concept may not be limited thereto. The present inventive concept may be applied to the pixel circuit PC including only the oxide semiconductor thin film transistors or the pixel circuit PC including only the polysilicon thin film transistors. Although some of switching elements of the pixel circuit PC are N-type transistors and other switching elements of the pixel circuit PC are P-type transistors in the present example, the present inventive concept may not be limited thereto. The present inventive concept may be applied to the pixel circuit PC including only the N-type transistors or the pixel circuit PC including only the P-type transistors.

For example, the pixel circuit PC may include a first switching element T1, a second switching element T2, a third switching element T3, a fourth switching element T4, a fifth switching element T5, a sixth switching element T6, a seventh switching element T7, an eighth switching element T8, a first capacitor CST, a second capacitor CBS and the light emitting element EE. For example, the first switching element T1 may be the driving switching element. For example, the second switching element T2 may be the writing switching element. For example, the third switching element T3 may be a compensation switching element. For example, the fourth switching element T4 may be a data initialization switching element. For example, the fifth switching element T5 may be a first emission switching element. For example, the sixth switching element T6 may be a second emission switching element. For example, the seventh switching element T7 may be a light emitting element initialization switching element. For example, the eighth switching element T8 may be a bias switching element.

The first switching element T1 may include a first switching element control electrode connected to a first node N1, a first switching element first electrode connected to a second node N2 and a first switching element second electrode connected to a third node N3.

The second switching element T2 may include a second switching element control electrode receiving the writing gate signal GW, a second switching element first electrode receiving the data voltage VDATA and a second switching element second electrode connected to the second node N2.

The third switching element T3 may include a third switching element control electrode receiving the compensation gate signal GC, a third switching element first electrode connected to the first node N1 and a third switching element second electrode connected to the third node N3.

The fourth switching element T4 may include a fourth switching element control electrode receiving the data initialization gate signal GI, a fourth switching element first electrode receiving a first initialization voltage VINIT and a fourth switching element second electrode connected to the first node N1.

The fifth switching element T5 may include a fifth switching element control electrode receiving the emission signal EM, a fifth switching element first electrode receiving a first power voltage ELVDD and a fifth switching element second electrode connected to the second node N2.

The sixth switching element T6 may include a sixth switching element control electrode receiving the emission signal EM, a sixth switching element first electrode connected to the third node N3 and a sixth switching element second electrode connected to an anode electrode of the light emitting element EE.

The seventh switching element T7 may include a seventh switching element control electrode receiving the bias gate signal GB, a seventh switching element first electrode receiving a second initialization voltage VAINIT and a seventh switching element second electrode connected to the anode electrode of the light emitting element EE. Although the second initialization voltage VAINIT is applied to the first electrode of the seventh switching element T7 in the present example, the present inventive concept may not be limited thereto. According to an example, the first initialization voltage VINIT may be applied to the first electrode of the seventh switching element T7. The bias gate signal GB may be referred to as a light emitting element initialization gate signal.

The eighth switching element T8 may include an eighth switching element control electrode receiving the bias gate signal GB, an eighth switching element first electrode receiving a bias voltage VOBS and an eighth switching element second electrode connected to the second node N2.

The first capacitor CST may include a first capacitor CST first electrode receiving the first power voltage ELVDD and a first capacitor CST second electrode connected to the first node N1.

The second capacitor CBS may include a second capacitor CBS first electrode receiving the writing gate signal GW and a second capacitor CBS second electrode connected to the first node N1.

The light emitting element EE includes the anode electrode and a cathode electrode receiving a second power voltage ELVSS.

The first power voltage ELVDD may be greater than the second power voltage ELVSS.

The driving current of the pixel may sequentially flow through the fifth switching element T5, the first switching element T1 and the sixth switching element T6 to drive the light emitting element EE. The intensity of the driving current may be determined by the level of the data voltage VDATA. A luminance of the light emitting element EE may be determined by the intensity of the driving current.

In the present example, when the display panel 100 displays a static image or the display panel 100 is operated in an always-on mode, a driving frequency of the display panel 100 may be decreased to reduce power consumption. When all of the switching elements of the pixel circuit PC of the display panel 100 are polysilicon thin film transistors, a flicker may occur due to a current leakage of the switching elements in a low driving frequency mode. Thus, some of the switching elements of the pixel circuit PC may be oxide semiconductor thin film transistors.

In the present example, the third switching element T3 and the fourth switching element T4 may be oxide semiconductor thin film transistors. The first switching element T1, the second switching element T2, the fifth switching element T5, the sixth switching element T6, the seventh switching element T7 and the eighth switching element T8 may be polysilicon thin film transistors. In the present example, the third switching element T3 and the fourth switching element T4 may be N-type transistors. The first switching element T1, the second switching element T2, the fifth switching element T5, the sixth switching element T6, the seventh switching element T7 and the eighth switching element T8 may be P-type transistors.

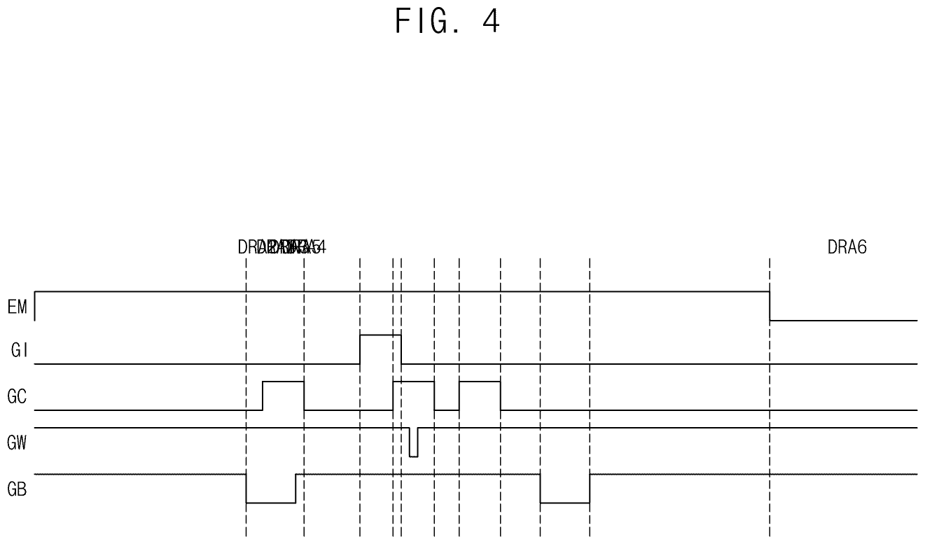

FIG. 4 is a timing diagram illustrating input signals applied to the pixel circuit PC and the sensing circuit SC of FIG. 3.

Referring to FIGS. 1 to 4, a driving timing of the pixel may include a first period DRA1, a second period DRA2, a third period DRA3, a fourth period DRA4, a fifth period DRA5 and a sixth period DRA6.

When the emission signal EM, the data initialization gate signal GI, the compensation gate signal GC, the writing gate signal GW and the bias gate signal GB are applied to P-type transistors, active levels of the emission signal EM, the data initialization gate signal GI, the compensation gate signal GC, the writing gate signal GW and the bias gate signal GB may be low levels and inactive levels of the emission signal EM, the data initialization gate signal GI, the compensation gate signal GC, the writing gate signal GW and the bias gate signal GB may be high levels.

When the emission signal EM, the data initialization gate signal GI, the compensation gate signal GC, the writing gate signal GW and the bias gate signal GB are applied to N-type transistors, the active levels of the emission signal EM, the data initialization gate signal GI, the compensation gate signal GC, the writing gate signal GW and the bias gate signal GB may be high levels and the inactive levels of the emission signal EM, the data initialization gate signal GI, the compensation gate signal GC, the writing gate signal GW and the bias gate signal GB may be low levels.

In the present example, the emission signal EM, the writing gate signal GW and the bias gate signal GB are applied to P-type transistors so that the active levels of the emission signal EM, the writing gate signal GW and the bias gate signal GB may be low levels and the inactive levels of the emission signal EM, the writing gate signal GW and the bias gate signal GB may be high levels.

In the present example, the data initialization gate signal GI and the compensation gate signal GC are applied to N-type transistors so that the active levels of the data initialization gate signal GI, the writing gate signal GW and the compensation gate signal GC may be high levels and the inactive levels of the data initialization gate signal GI, the writing gate signal GW and the compensation gate signal GC may be low levels.

In the first period DRA1, the emission signal EM may have an inactive level, the data initialization gate signal GI may have an inactive level, the compensation gate signal GC may have an active pulse, the writing gate signal GW may have an inactive level and the bias gate signal GB may have an active pulse.

In the first period DRA1, the seventh switching element T7 may be turned on in response to the bias gate signal GB so that the second initialization voltage VAINIT may be applied to the anode electrode of the light emitting element EE.

In the first period DRA1, the eighth switching element T8 may be turned on in response to the bias gate signal GB so that the bias voltage VOBS may be applied to the second node N2.

In the first period DRA1, the third switching element T3 may be turned on in response to the compensation gate signal GC so that the first node N1 and the third node N3 may be connected to each other.

In the second period DRA2 subsequent to the first period DRA1, the emission signal EM may have the inactive level, the data initialization gate signal GI may have an active level, the compensation gate signal GC may have an inactive level, the writing gate signal GW may have the inactive level and the bias gate signal GB may have an inactive level.

In the second period DRA2, the fourth switching element T4 may be turned on in response to the data initialization gate signal GI so that the first initialization voltage VINIT may be applied to the first node N1.

In the third period DRA3 subsequent to the second period DRA2, the emission signal EM may have the inactive level, the data initialization gate signal GI may have the inactive level, the compensation gate signal GC may have an active level, the writing gate signal GW may have an active pulse and the bias gate signal GB may have the inactive level.

In the third period DRA3, the second switching element T2 may be turned on in response to the compensation gate signal GC so that the data voltage VDATA in which the threshold voltage of the first switching element T1 is compensated may be applied to the first node N1.

In the fourth period DRA4 subsequent to the third period DRA3, the emission signal EM may have the inactive level, the data initialization gate signal GI may have the inactive level, the compensation gate signal GC may have the active level, the writing gate signal GW may have the inactive level and the bias gate signal GB may have the inactive level.

In the fourth period DRA4, the third switching element T3 may be turned on in response to the compensation gate signal GC so that the first node N1 and the third node N3 may be connected to each other.

The fourth period DRA4 is not essential so that the fourth period DRA4 may be omitted from the driving timing of the pixel.

In the fifth period DRA5 subsequent to the fourth period DRA4, the emission signal EM may have the inactive level, the data initialization gate signal GI may have the inactive level, the compensation gate signal GC may have the inactive level, the writing gate signal GW may have the inactive level and the bias gate signal GB may have an active level.

In the fifth period DRA5, the seventh switching element T7 may be turned on in response to the bias gate signal GB so that the second initialization voltage VAINIT may be applied to the anode electrode of the light emitting element EE.

In the sixth period DRA6 subsequent to the fifth period DRA5, the emission signal EM may have an active level, the data initialization gate signal GI may have the inactive level, the compensation gate signal GC may have the inactive level, the writing gate signal GW may have the inactive level and the bias gate signal GB may have the inactive level.

In the sixth period DRA6, the fifth switching element T5 and the sixth switching element T6 may be turned on in response to the emission signal EM and the first switching element T1 may be turned on in response to the data voltage VDATA so that the light emitting element EE may emit a light.

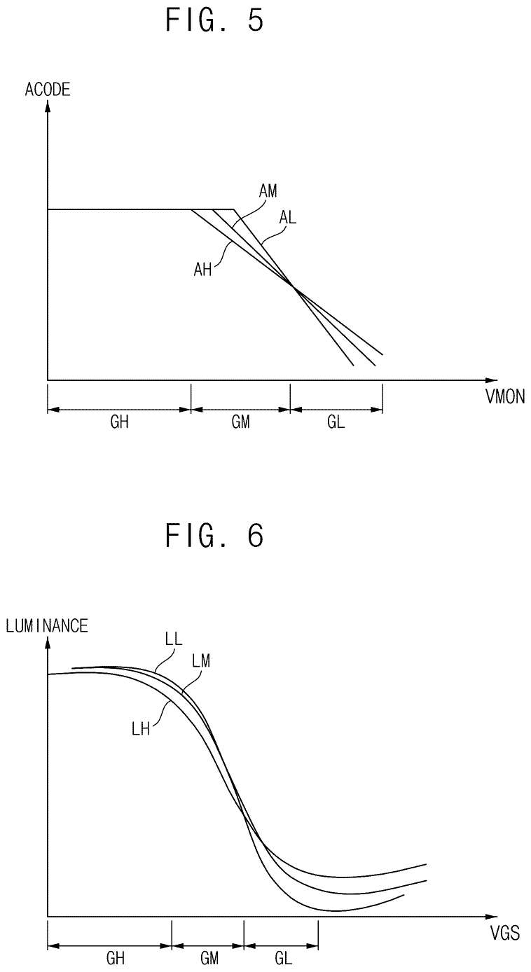

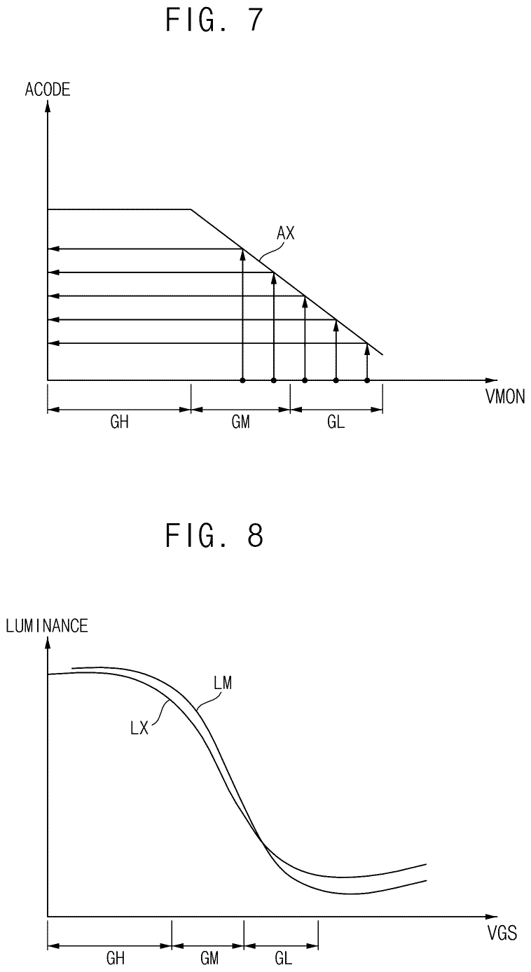

FIG. 5 is a diagram illustrating a voltage-current curve of the first sensing switching element T9 of FIG. 3 according to a first temperature, a second temperature and a third temperature. FIG. 6 is a diagram illustrating a voltage-current curve of the driving switching element T1 and the light emitting element EE of FIG. 3 according to the first temperature, the second temperature and the third temperature. FIG. 7 is a diagram illustrating a temperature sensing using the sensing circuit SC of FIG. 3. FIG. 8 is a diagram illustrating a data compensation of the pixel circuit PC of FIG. 3 based on the temperature sensing of FIG. 7.

Referring to FIGS. 1 to 8, a voltage-current correlation of the first sensing switching element T9 according to the first temperature, the second temperature and the third temperature may be determined using the sensing circuit SC. Herein, the first temperature may be a high temperature, the second temperature may be a room temperature and the third temperature may be a low temperature.

Although the voltage-current correlation of the first sensing switching element T9 is determined at three different temperatures in the present example, the present inventive concept may not be limited thereto. The voltage-current correlation of the first sensing switching element T9 may be determined at four or more different temperatures.

In FIG. 5, a first curve AH represents that the sensed current IS of the first sensing switching element T9 is converted into a digital code ACODE for the monitoring voltage VMON applied to the control electrode of the first sensing switching element T9 at the high temperature.

In FIG. 5, a second curve AM represents that the sensed current IS of the first sensing switching element T9 is converted into the digital code ACODE for the monitoring voltage VMON applied to the control electrode of the first sensing switching element T9 at the room temperature.

In FIG. 5, a third curve AL represents that the sensed current IS of the first sensing switching element T9 is converted into the digital code ACODE for the monitoring voltage VMON applied to the control electrode of the first sensing switching element T9 at the low temperature.

A voltage-luminance correlation of the driving switching element T1 and the light emitting element EE according to the first temperature, the second temperature and the third temperature may be determined using the pixel circuit PC.

Although voltage-luminance correlation of the driving switching element T1 and the light emitting element EE is determined at three different temperatures in the present example, the present inventive concept may not be limited thereto. The voltage-luminance correlation of the driving switching element T1 and the light emitting element EE may be determined at four or more different temperatures.

In FIG. 6, a first curve LH represents that a luminance of the light emitting element EE according to a gate-source voltage VGS of the first switching element T1 at high temperature.

In FIG. 6, a second curve LM represents the luminance of the light emitting element EE according to the gate-source voltage VGS of the first switching element T1 at room temperature.

In FIG. 6, a third curve LL represents that the luminance of the light emitting element EE according to the gate-source voltage VGS of the first switching element T1 at the low temperature.

The voltage-current correlation and the voltage-luminance correlation according to the first temperature, the second temperature and the third temperature may be matched to each other. The matching results may be stored in a memory in the display panel driver.

Thereafter, in a temperature sensing mode of the display panel 100, the sensed current IS may be received through the readout line RL while changing the monitoring voltage VMON applied to the control electrode of the first sensing switching element T9. The temperatures for the positions of the display panel 100 may be determined based on the sensed current IS.

The temperature sensing mode may be operated when the display panel 100 is driven. An operation of the sensing circuit SC may be independent from the operation of the light emitting element EE of the pixel circuit PC so that the temperature sensing mode may be operated in real time during the operation of the display panel 100.

For example, the temperature sensing mode may be operated in a predetermined cycle during the operation of the display panel 100. For example, the temperature sensing mode may be operated during a turn-on operation and a turn-off operation of the display panel 100. For example, the temperature sensing mode may be operated when the driving controller 200 receives a temperature change signal from the host.

For example, a size of the first sensing switching element T9 of the sensing circuit SC may be substantially the same as a size of the driving switching element T1 of the pixel circuit PC.

The first sensing switching element T9 of the sensing circuit SC may function as a twin of the driving switching element T1 of the pixel circuit PC. Thus, a characteristic of the driving switching element T1 of the pixel circuit PC may be predicted by sensing a characteristic of the first sensing switching element T9 of the sensing circuit SC. For example, the temperature of the pixel circuit PC may be predicted by determining the voltage-current correlation of the first sensing switching element T9 of the sensing circuit SC.

For this, the monitoring voltage VMON applied to the control electrode of the first sensing switching element T9 may be determined by subtracting the target threshold voltage of the driving switching element T1 from the data voltage VDATA.

When the temperatures for the positions of the display panel 100 are determined, the data signal DATA may be compensated based on the temperatures for the positions and the data voltage VDATA may be generated based on the data signal DATA.

In FIG. 7, by changing the monitoring voltage VMON several times and receiving the sensed current IS through the readout line RL, the digital code ACODE for the sensed current IS may be determined.

After determining a present voltage-current correlation AX of a present position based on the digital code ACODE according to the monitoring voltages VMON, a present temperature of the present position may be predicted by comparing the present voltage-current correlation AX to voltage-current correlations AH, AM and AL of FIG. 5 which are stored already.

The present voltage-current correlation AX of FIG. 7 is similar to the first curve AH of FIG. 5 so that it can be seen that the present temperature of the present position is close to the first temperature (high temperature).

The data signal DATA may be compensated in FIG. 8 using the matching result of the voltage-current correlation and the voltage-luminance correlation according to the first temperature, the second temperature and the third temperature.

For example, the present temperature of the present position in FIG. 7 is the high temperature so that the data signal DATA may be compensated for such that a luminance of the light emitting element EE of the pixel circuit PC moves from the high-temperature curve LX to the room-temperature curve LM.

A shift of the luminance and a shift of the color coordinate according to the temperature may be perceived by a user in a low grayscale value so that the data signal DATA may be compensated mainly in a low grayscale range GL among a high grayscale range GH, a middle grayscale range GM and the low grayscale range GL.

For this reason, the monitoring voltage VMON may be applied and the sensed current IS may be received mainly in the low grayscale range GL and the middle grayscale range GM in FIG. 7.

As the temperature increases, the luminance may generally increase in the low grayscale range GL. Thus, when the temperature is sensed to be higher than the room temperature in the low grayscale range GL, the data signal DATA may be compensated in the direction of decreasing the luminance. In contrast, as the temperature decreases, the luminance may generally decrease in the low grayscale range GL. Thus, when the temperature is sensed to be lower than the room temperature in the low grayscale range GL, the data signal DATA may be compensated for in the direction of increasing the luminance.

The amount of compensation of the data signal DATA according to the temperature may be determined using the matching result of the voltage-current correlation and the voltage-luminance correlation according to the first temperature, the second temperature and the third temperature which is stored in the display panel driver.

According to the present example, the display panel 100 includes the sensing circuit SC including the first sensing switching element T9 and the second sensing switching element T10. The display apparatus may sense the temperatures for the positions of the display panel 100 in real time using the sensing circuit SC and compensate the data voltage VDATA using the temperatures for the positions. Thus, the display quality of the display panel 100 may be enhanced.

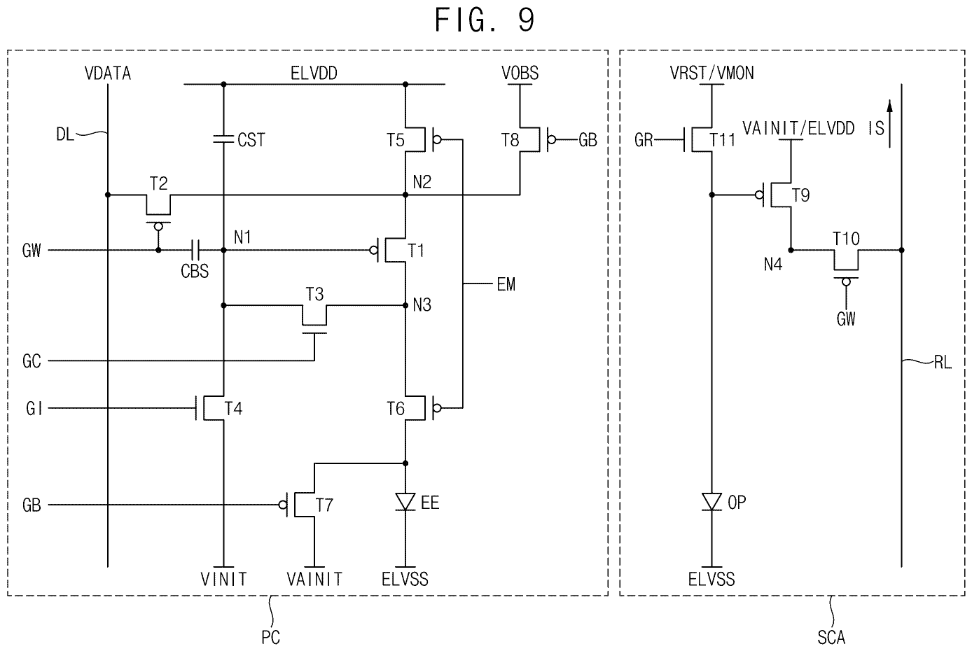

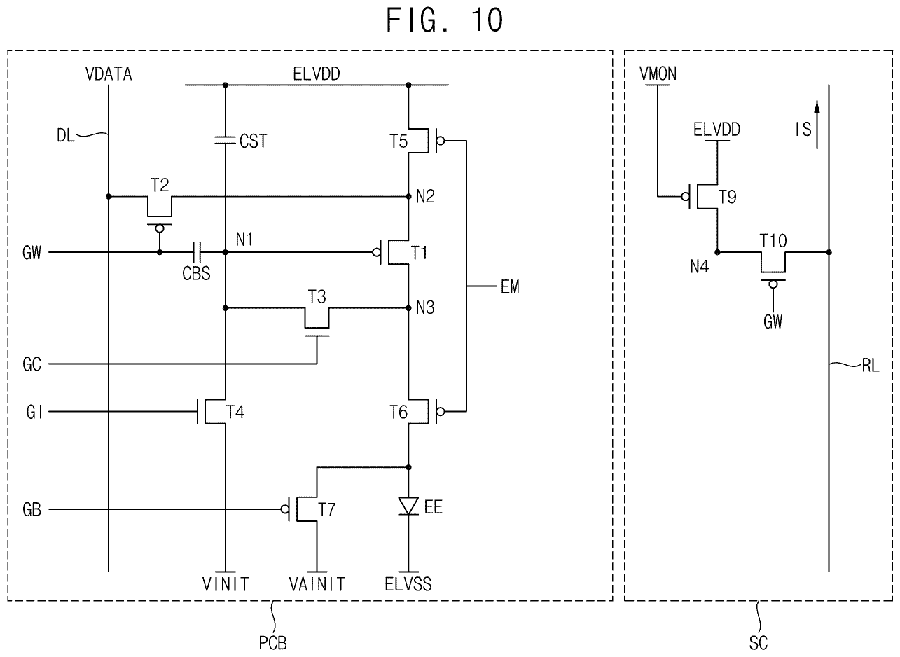

FIG. 9 is a circuit diagram illustrating a pixel circuit PC and a sensing circuit SCA of a display panel 100 according to an example of the present inventive concept.

The display apparatus according to the present example is substantially the same as the display apparatus of the previous example explained referring to FIGS. 1 to 8 except for the structure of the sensing circuit. Thus, the same reference numerals will be used to refer to the same or like parts as those described in the previous example of FIGS. 1 to 8 and any repetitive explanation concerning the above elements will be omitted.

Referring to FIGS. 1 to 2C and 4 to 9, the display panel 100 includes a plurality of pixel circuits PC and a plurality of sensing circuits SCA.

The pixel circuit PC receives a writing gate signal GW, a compensation gate signal GC, a data initialization gate signal GI, a bias gate signal GB, the data voltage VDATA and the emission signal EM and displays an image according to a level of the data voltage VDATA.

The pixel circuit PC includes a light emitting element EE, a driving switching element T1 transmitting a driving current to the light emitting element EE, a writing switching element T2 applying the data voltage VDATA to the driving switching element T1 in response to the writing gate signal GW.

The sensing circuit SCA receives the writing gate signal GW and the monitoring voltage VMON and outputs the sensed current IS.

The sensing circuit SCA includes a first sensing switching element T9 including a first electrode receiving a first power voltage ELVDD and a second electrode connected to a fourth node N4 and a second sensing switching element T10 including a control electrode receiving the writing gate signal GW, a first electrode connected to the fourth node N4 and a second electrode connected to the readout line RL.

The sensing circuit SCA may further include a third sensing switching element T11 including a third sensing switch element control electrode receiving a sensing gate signal GR, a first electrode receiving a reset voltage VRST or a monitoring voltage VMON and a second electrode connected to a control electrode of the first sensing switching element T9 and a photo diode OP including a first electrode connected to the control electrode of the first sensing switching element T9 and a second electrode receiving a second power voltage ELVSS.

The photo diode OP may operate as fingerprint recognition sensor or a blood vessel recognition sensor.

The sensing circuit SCA may sense temperatures for positions and sense a fingerprint or a blood vessel of a user. For example, the sensing circuit SCA may sense the temperatures for the positions of the display panel 100 in a first sensing mode and the sensing circuit SCA may sense the fingerprint or the blood vessel of the user in a second sensing mode.

In the first sensing mode, the sensing gate signal GR may maintain an active level, the monitoring voltage VMON may be applied to the first electrode of the third sensing switching element T11 and the first power voltage ELVDD may be applied to the first electrode of the first sensing switching element T9.

In the first sensing mode, the third sensing switching element T11 may be turned on and the monitoring voltage VMON may be applied to the control electrode of the first sensing switching element T9 through the third sensing switching element T11 so that the sensing circuit SCA of FIG. 9 may operate substantially the same as the sensing circuit SC of FIG. 3 in the first sensing mode.

In the second sensing mode, the reset voltage VRST may be applied to the first electrode of the third sensing switching element T11 and the second initialization voltage VAINIT may be applied to the first electrode of the first sensing element T9. The reset voltage VRST and the second initialization voltage VAINIT may be voltages for the sensing circuit SCA of FIG. 9 to sense the fingerprint or the blood vessel of the user.

According to the present example, the display panel 100 includes the sensing circuit SCA including the first sensing switching element T9 and the second sensing switching element T10. The display apparatus may sense the temperatures for the positions of the display panel 100 in real time using the sensing circuit SCA and compensate the data voltage VDATA using the temperatures for the positions. Thus, the display quality of the display panel 100 may be enhanced.

FIG. 10 is a circuit diagram illustrating a pixel circuit PCB and a sensing circuit SC of a display panel 100 according to an example of the present inventive concept.

The display apparatus according to the present example is substantially the same as the display apparatus of the previous example explained referring to FIGS. 1 to 8 except for the structure of the pixel circuit. Thus, the same reference numerals will be used to refer to the same or like parts as those described in the previous example of FIGS. 1 to 8 and any repetitive explanation concerning the above elements will be omitted.

Referring to FIGS. 1 to 2C, 4 to 8 and 10, the display panel 100 includes a plurality of pixel circuits PCB and a plurality of sensing circuits SC.

The pixel circuit PCB receives a writing gate signal GW, a compensation gate signal GC, a data initialization gate signal GI, a bias gate signal GB, the data voltage VDATA and the emission signal EM and displays an image according to a level of the data voltage VDATA.

The pixel circuit PCB includes a light emitting element EE, a driving switching element T1 transmitting a driving current to the light emitting element EE, a writing switching element T2 applying the data voltage VDATA to the driving switching element T1 in response to the writing gate signal GW.

The pixel circuit PCB of FIG. 10 may be substantially the same as the pixel circuit PC of FIG. 3 except that the pixel circuit PCB of FIG. 10 does not include the eighth switching element T8 of the pixel circuit PC of FIG. 3.

The sensing circuit SC receives the writing gate signal GW and the monitoring voltage VMON and outputs the sensed current IS.

The sensing circuit SC includes a first sensing switching element T9 including a first electrode receiving a first power voltage ELVDD and a second electrode connected to a fourth node N4 and a second sensing switching element T10 including a control electrode receiving the writing gate signal GW, a first electrode connected to the fourth node N4 and a second electrode connected to the readout line RL.

According to the present example, the display panel 100 includes the sensing circuit SC including the first sensing switching element T9 and the second sensing switching element T10. The display apparatus may sense the temperatures for the positions of the display panel 100 in real time using the sensing circuit SC and compensate the data voltage VDATA using the temperatures for the positions. Thus, the display quality of the display panel 100 may be enhanced.

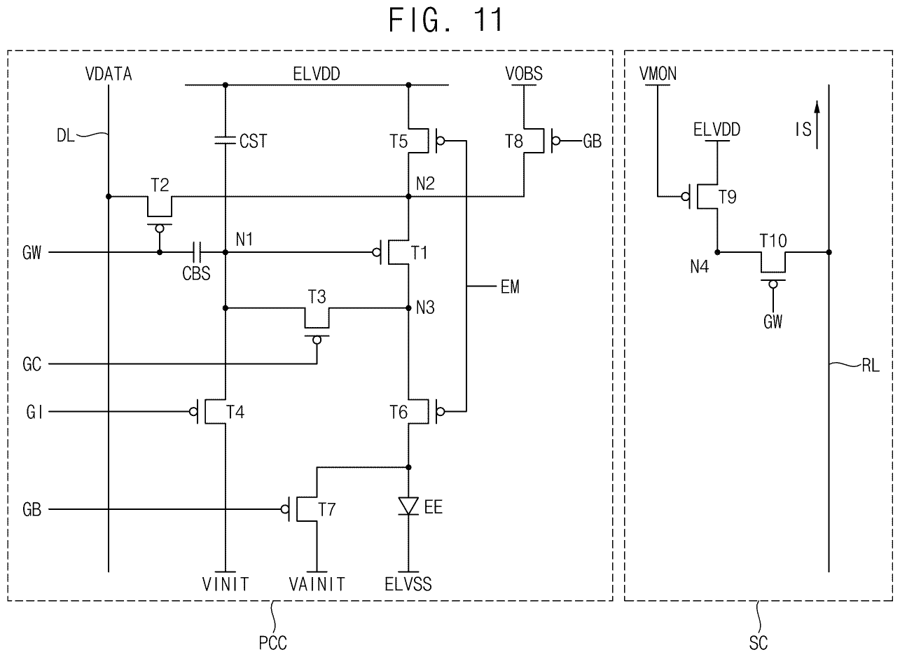

FIG. 11 is a circuit diagram illustrating a pixel circuit PCC and a sensing circuit SC of a display panel 100 according to an example of the present inventive concept.

The display apparatus according to the present example is substantially the same as the display apparatus of the previous example explained referring to FIGS. 1 to 8 except for the structure of the pixel circuit. Thus, the same reference numerals will be used to refer to the same or like parts as those described in the previous example of FIGS. 1 to 8 and any repetitive explanation concerning the above elements will be omitted.

Referring to FIGS. 1 to 2C, 5 to 8 and 11, the display panel 100 includes a plurality of pixel circuits PCC and a plurality of sensing circuits SC.

The pixel circuit PCC receives a writing gate signal GW, a compensation gate signal GC, a data initialization gate signal GI, a bias gate signal GB, the data voltage VDATA and the emission signal EM and displays an image according to a level of the data voltage VDATA.

The pixel circuit PCC includes a light emitting element EE, a driving switching element T1 transmitting a driving current to the light emitting element EE, a writing switching element T2 applying the data voltage VDATA to the driving switching element T1 in response to the writing gate signal GW.

The pixel circuit PCC of FIG. 11 may be substantially the same as the pixel circuit PC of FIG. 3 except that the third switching element T3 and the fourth switching element T4 are P-type transistors. In the present example, the third switching element T3 and the fourth switching element T4 are P-type transistors so that waveforms of the compensation gate signal GC and the data initialization gate signal GI may be opposite to the waveforms of the compensation gate signal GC and the data initialization gate signal GI in FIG. 4.

The sensing circuit SC receives the writing gate signal GW and the monitoring voltage VMON and outputs the sensed current IS.

The sensing circuit SC includes a first sensing switching element T9 including a first electrode receiving a first power voltage ELVDD and a second electrode connected to a fourth node N4 and a second sensing switching element T10 including a control electrode receiving the writing gate signal GW, a first electrode connected to the fourth node N4 and a second electrode connected to the readout line RL.

According to the present example, the display panel 100 includes the sensing circuit SC including the first sensing switching element T9 and the second sensing switching element T10. The display apparatus may sense the temperatures for the positions of the display panel 100 in real time using the sensing circuit SC and compensate the data voltage VDATA using the temperatures for the positions. Thus, the display quality of the display panel 100 may be enhanced.

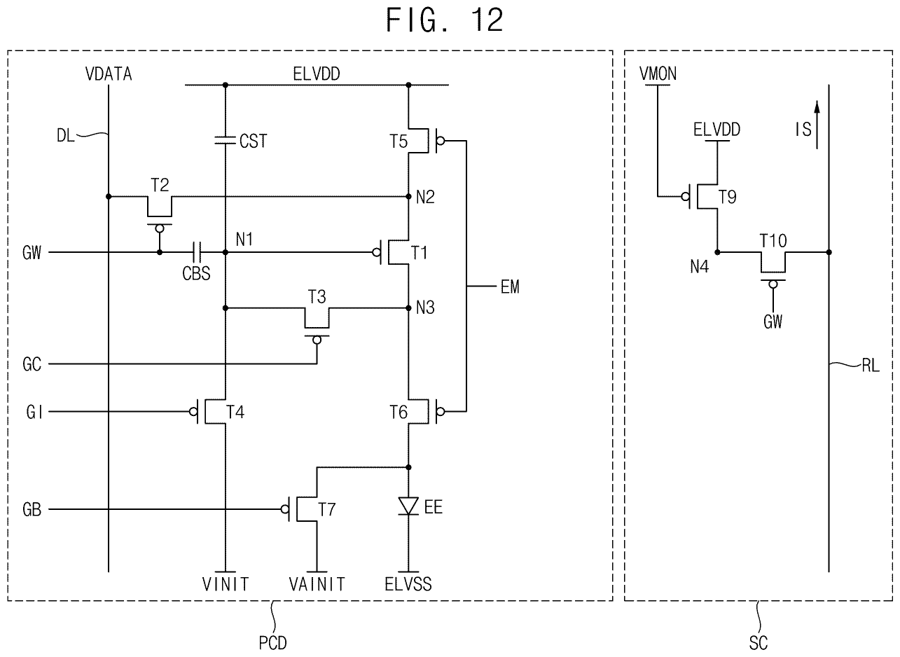

FIG. 12 is a circuit diagram illustrating a pixel circuit PCD and a sensing circuit SC of a display panel 100 according to an example of the present inventive concept.

The display apparatus according to the present example is substantially the same as the display apparatus of the previous example explained referring to FIGS. 1 to 8 except for the structure of the pixel circuit. Thus, the same reference numerals will be used to refer to the same or like parts as those described in the previous example of FIGS. 1 to 8 and any repetitive explanation concerning the above elements will be omitted.

Referring to FIGS. 1 to 2C, 5 to 8 and 12, the display panel 100 includes a plurality of pixel circuits PCD and a plurality of sensing circuits SC.

The pixel circuit PCD receives a writing gate signal GW, a compensation gate signal GC, a data initialization gate signal GI, a bias gate signal GB, the data voltage VDATA and the emission signal EM and displays an image according to a level of the data voltage VDATA.

The pixel circuit PCD includes a light emitting element EE, a driving switching element T1 transmitting a driving current to the light emitting element EE, a writing switching element T2 applying the data voltage VDATA to the driving switching element T1 in response to the writing gate signal GW.

The pixel circuit PCD of FIG. 12 may be substantially the same as the pixel circuit PC of FIG. 3 except that the third switching element T3 and the fourth switching element T4 are P-type transistors and the pixel circuit PCD of FIG. 12 does not include the eighth switching element T8 of the pixel circuit PC of FIG. 3. In the present example, the third switching element T3 and the fourth switching element T4 are P-type transistors so that waveforms of the compensation gate signal GC and the data initialization gate signal GI may be opposite to the waveforms of the compensation gate signal GC and the data initialization gate signal GI in FIG. 4.

The sensing circuit SC receives the writing gate signal GW and the monitoring voltage VMON and outputs the sensed current IS.

The sensing circuit SC includes a first sensing switching element T9 including a first electrode receiving a first power voltage ELVDD and a second electrode connected to a fourth node N4 and a second sensing switching element T10 including a control electrode receiving the writing gate signal GW, a first electrode connected to the fourth node N4 and a second electrode connected to the readout line RL.

According to the present example, the display panel 100 includes the sensing circuit SC including the first sensing switching element T9 and the second sensing switching element T10. The display apparatus may sense the temperatures for the positions of the display panel 100 in real time using the sensing circuit SC and compensate the data voltage VDATA using the temperatures for the positions. Thus, the display quality of the display panel 100 may be enhanced.

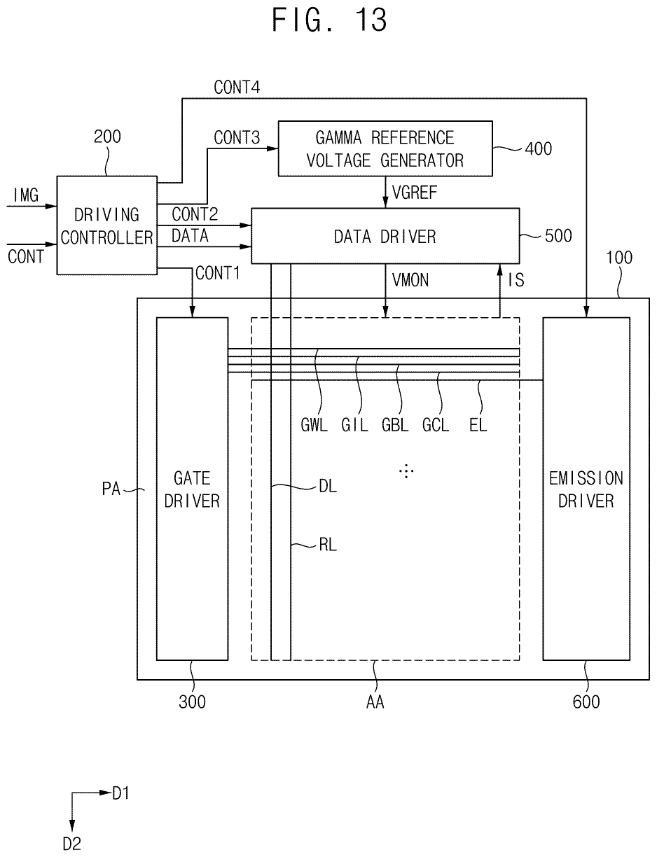

FIG. 13 is a block diagram illustrating a display apparatus according to an example of the present inventive concept.

The display apparatus according to the present example is substantially the same as the display apparatus of the previous example explained referring to FIGS. 1 to 8 except that the data driver and the sensing driver are integratedly formed. Thus, the same reference numerals will be used to refer to the same or like parts as those described in the previous example of FIGS. 1 to 8 and any repetitive explanation concerning the above elements will be omitted.

Referring to FIGS. 2 to 8 and 13, the data driver 500 may receive the second control signal CONT2 and the data signal DATA from the driving controller 200, and may receive the gamma reference voltages VGREF from the gamma reference voltage generator 400. The data driver 500 may convert the data signal DATA into data voltages having an analog type using the gamma reference voltages VGREF. The data driver 500 may output the data voltages to the data lines DL. For example, the data driver 500 may apply the data voltage to the pixel circuit of the display panel 100.

The data driver 500 may output a monitoring voltage VMON in response to the second control signal CONT2 received from the driving controller 200. For example, the data driver 500 may output the monitoring voltage VMON to the sensing circuit of the display panel 100.

The data driver 500 may receive a sensed current IS from the display panel 100. For example, the data driver 500 may receive the sensed current IS from the sensing circuit of the display panel 100. For example, the data driver 500 may receive the sensed current IS through a readout line RL while changing the monitoring voltage VMON.

The data driver 500 may determine temperatures for positions of the display panel 100 based on the sensed current IS. The data driver 500 may output the temperatures for the positions to the driving controller 200. Alternatively, the data driver 500 may output the sensed current IS to the driving controller 200. The driving controller 200 may determine the temperatures for the positions based on the sensed current IS.

The driving controller 200 may compensate for the data signal DATA based on the temperatures for the positions.

The data driver 500 may generate the data voltage based on the compensated data signal DATA and may apply the data voltage to the pixel circuit.

The display panel 100 includes a plurality of pixel circuits PC and a plurality of sensing circuits SC.

The pixel circuit PC receives a writing gate signal GW, a compensation gate signal GC, a data initialization gate signal GI, a bias gate signal GB, the data voltage VDATA and the emission signal EM and displays an image according to a level of the data voltage VDATA.

The pixel circuit PC includes a light emitting element EE, a driving switching element T1 transmitting a driving current to the light emitting element EE, a writing switching element T2 applying the data voltage VDATA to the driving switching element T1 in response to the writing gate signal GW.

The sensing circuit SC receives the writing gate signal GW and the monitoring voltage VMON and outputs the sensed current IS.

The sensing circuit SC includes a first sensing switching element T9 including a first electrode receiving a first power voltage ELVDD and a second electrode connected to a fourth node N4 and a second sensing switching element T10 including a control electrode receiving the writing gate signal GW, a second sensing switching element first electrode connected to the fourth node N4 and a second sensing switching element second electrode connected to the readout line RL.

According to the present example, the display panel 100 includes the sensing circuit SC including the first sensing switching element T9 and the second sensing switching element T10. The display apparatus may sense the temperatures for the positions of the display panel 100 in real time using the sensing circuit SC and compensate the data voltage VDATA using the temperatures for the positions. Thus, the display quality of the display panel 100 may be enhanced.

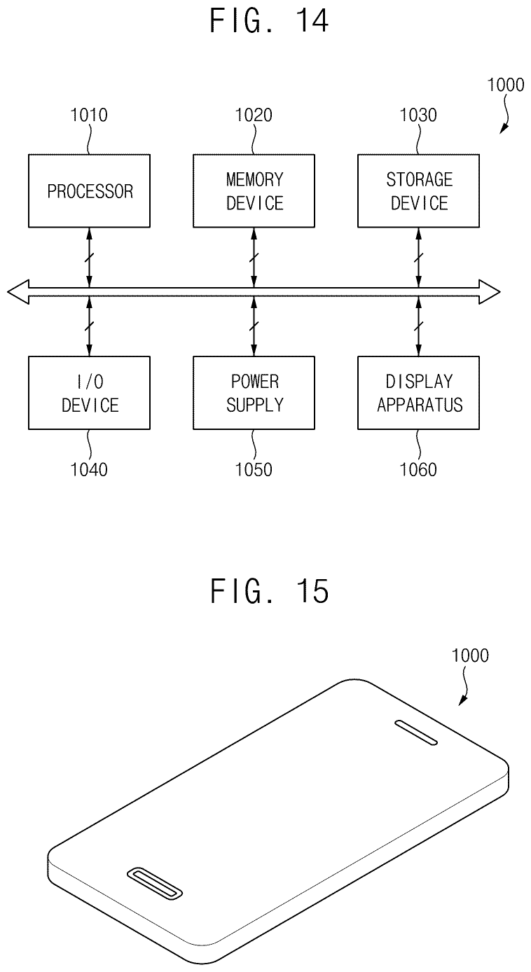

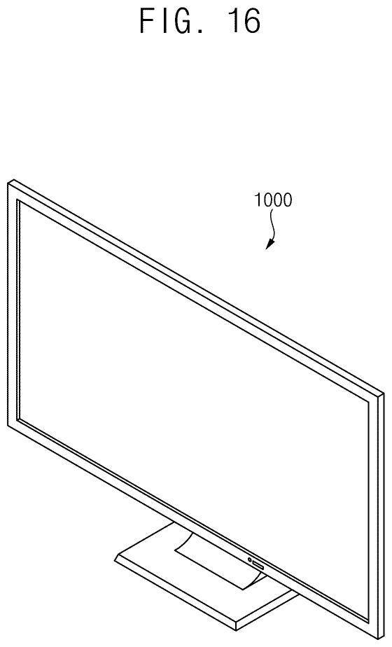

FIG. 14 is a block diagram illustrating an electronic apparatus 1000 according to an example of the present inventive concept. FIG. 15 is a diagram illustrating an example in which the electronic apparatus 1000 of FIG. 14 is implemented as a smartphone. FIG. 16 is a diagram illustrating an example in which the electronic apparatus 1000 of FIG. 14 is implemented as a monitor.

Referring to FIGS. 14 to 16, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an example, as illustrated in FIG. 15, the electronic apparatus 1000 may be implemented as a smartphone. In an example, as illustrated in FIG. 16, the electronic apparatus 1000 may be implemented as a monitor. However, the electronic apparatus 1000 is not limited thereto. For example, the electronic apparatus 1000 may be implemented as a television, a cellular phone, a video phone, a smart pad, a smart watch, a tablet PC, a car navigation system, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some examples, the display apparatus 1060 may be included in the I/O device 1040. The power supply 1050 may provide power for operations of the electronic apparatus 1000. The display apparatus 1060 may be coupled to other components via the buses or other communication links.

According to the examples of the display panel, the display apparatus including the display panel and the electronic apparatus including the display apparatus, the temperatures for the positions of the display panel may be sensed and the data voltage may be compensated based on the temperatures for the positions so that the display quality of the display panel may be enhanced.

The foregoing is illustrative of the present inventive concept and is not to be construed as limiting thereof. Although a few examples of the present inventive concept have been described, those skilled in the art will readily appreciate that many modifications are possible in the examples without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific examples disclosed, and that modifications to the disclosed examples, as well as other examples, are intended to be included within the scope of the appended claims. The present inventive concept is defined by the following claims, with equivalents of the claims to be included therein.

What is claimed is:

1. A display panel comprising:
a pixel circuit including a light emitting element, and a driving switching element configured to transmit a driving current to the light emitting element; and a writing switching element configured to apply a data voltage to the driving switching element in response to a writing gate signal; and
a sensing circuit including:
a first sensing switching element having a first sensing switching element first electrode configured to receive a first power voltage and a first sensing switching element second electrode connected to a fourth node; and
a second sensing switching element having a second sensing switching control electrode configured to receive the writing gate signal, a second sensing switching element first electrode connected to the fourth node and a second sensing switching element second electrode connected to a readout line.

2. The display panel of claim 1, wherein the first sensing switching element further includes a first sensing switching element control electrode configured to receive a monitoring voltage, and
wherein the monitoring voltage is determined by subtracting a target threshold voltage of the driving switching element from the data voltage.

3. The display panel of claim 1, wherein the sensing circuit further comprises:
a third sensing switching element including a third sensing switching element control electrode configured to receive a sensing gate signal, a third sensing switching element first electrode configured to receive a reset voltage or a monitoring voltage and a third sensing switching element second electrode connected to a first sensing switching element control electrode; and
a photo diode including a photo diode first electrode connected to the first sensing switching element control electrode and a photo diode second electrode configured to receive a second power voltage.

4. The display panel of claim 3, wherein, in a first sensing mode, an active level of the sensing gate signal is maintained, the monitoring voltage is applied to the third sensing switching element first electrode and the first power voltage is applied to the first sensing switching element first electrode of the first sensing switching element, and
wherein, in a second sensing mode, the reset voltage is applied to the third sensing switching element first electrode and a second initialization voltage is applied to the first sensing switching element first electrode.

5. The display panel of claim 1, wherein the pixel circuit further comprises:
a compensation switching element including a compensation switching element control electrode configured to receive a compensation gate signal, a compensation switching element first electrode connected to a driving switching element control electrode and a compensation switching element second electrode connected to a driving switching element second electrode; and
a data initialization switching element including a data initialization switching element control electrode configured to receive a data initialization gate signal, a data initialization switching element first electrode configured to receive a first initialization voltage and a data initialization switching element second electrode connected to the driving switching element control electrode.

6. The display panel of claim 5, wherein the driving switching element and the writing switching element are P-type transistors, and
wherein the compensation switching element and the data initialization switching element are N-type transistors.

7. The display panel of claim 5, wherein the driving switching element, the writing switching element, the compensation switching element and the data initialization switching element are P-type transistors.

8. The display panel of claim 1, wherein the pixel circuit further comprises:
a light emitting element initialization switching element including a light emitting element initialization switching control electrode configured to receive a bias gate signal, a light emitting element initialization switching first electrode configured to receive a second initialization voltage and a light emitting element initialization switching second electrode connected to an anode electrode of the light emitting element.

9. The display panel of claim 8, wherein the pixel circuit further comprises:
a bias switching element including a bias switching element control electrode configured to receive the bias gate signal, a bias switching element first electrode configured to receive a bias voltage and a bias switching element second electrode connected to a driving switching element first electrode.

10. The display panel of claim 1, wherein the driving switching element includes a driving switching element control electrode connected to a first node, a driving switching element first electrode connected to a second node and a driving switching element second electrode connected to a third node,
wherein the writing switching element includes a writing switching element control electrode configured to receive the writing gate signal, a writing switching element first electrode configured to receive the data voltage and a writing switching element second electrode connected to the second node,
wherein the pixel circuit further comprises:
a compensation switching element including a compensation switching element control electrode configured to receive a compensation gate signal, a compensation switching element first electrode connected to the first node and a compensation switching element second electrode connected to the third node;
a data initialization switching element including a data initialization switching element control electrode configured to receive a data initialization gate signal, a data initialization switching element first electrode configured to receive a first initialization voltage and a data initialization switching element second electrode connected to the first node;
a first emission switching element including a first emission switching element control electrode configured to receive an emission signal, a first emission switching element first electrode configured to receive a first power voltage and a first emission switching element second electrode connected to the second node;
a second emission switching element including a second emission switching element control electrode configured to receive the emission signal, a second emission switching element first electrode connected to the third node and a second emission switching element second electrode connected to an anode electrode of the light emitting element;
a light emitting element initialization switching element including a light emitting element initialization switching element control electrode configured to receive a bias gate signal, a light emitting element initialization switching element first electrode configured to receive a second initialization voltage and a light emitting element initialization switching element second electrode connected to the anode electrode of the light emitting element;
a bias switching element including a bias switching element control electrode configured to receive the bias gate signal, a bias switching element first electrode configured to receive a bias voltage and a bias switching element second electrode connected to the second node; and
a first capacitor including a first capacitor first electrode configured to receive the first power voltage and a first capacitor second electrode connected to the first node.

11. The display panel of claim 10, wherein the emission signal has an inactive level in a first period, the data initialization gate signal has an inactive level in the first period, the compensation gate signal has an active pulse in the first period, the writing gate signal has an inactive level in the first period and the bias gate signal has an active pulse in the first period,
wherein the emission signal has the inactive level in a second period subsequent to the first period, the data initialization gate signal has an active level in the second period, the compensation gate signal has an inactive level in the second period, the writing gate signal has the inactive level in the second period and the bias gate signal has an inactive level in the second period,
wherein the emission signal has the inactive level in a third period subsequent to the second period, the data initialization gate signal has the inactive level in the third period, the compensation gate signal has an active level in the third period, the writing gate signal has an active pulse in the third period and the bias gate signal has the inactive level in the third period, and
wherein the emission signal has the inactive level in a fifth period subsequent to the third period, the data initialization gate signal has the inactive level in the fifth period, the compensation gate signal has the inactive level in the fifth period, the writing gate signal has the inactive level in the fifth period and the bias gate signal has the inactive level in the fifth period.

12. The display panel of claim 11, wherein the emission signal has the inactive level in a fourth period between the third period and the fifth period, the data initialization gate signal has the inactive level in the fourth period, the compensation gate signal has the active level in the fourth period, the writing gate signal has the inactive level in the fourth period and the bias gate signal has the inactive level in the fourth period.

13. The display panel of claim 1, wherein a ratio between number of the pixel circuits and number of the sensing circuits is 1:1 in the display panel, and
wherein a first pixel row of the display panel includes a first pixel circuit, a first sensing circuit, a second pixel circuit, a second sensing circuit, a third pixel circuit, a third sensing circuit, a fourth pixel circuit and a fourth sensing circuit which are sequentially disposed.

14. The display panel of claim 1, wherein a ratio between number of the pixel circuits and number of the sensing circuits is 4:1 in the display panel, and
wherein a first pixel row of the display panel includes a first pixel circuit, a second pixel circuit, a first sensing circuit, a third pixel circuit, a fourth pixel circuit, a fifth pixel circuit, a sixth pixel circuit, a second sensing circuit, a seventh pixel circuit and an eighth pixel circuit which are sequentially disposed.

15. The display panel of claim 1, wherein a ratio between number of the pixel circuits and number of the sensing circuits is 8:1 in the display panel, and
wherein a first pixel row of the display panel includes a first pixel circuit, a second pixel circuit, a third pixel circuit, a fourth pixel circuit, a first sensing circuit, a fifth pixel circuit, a sixth pixel circuit, a seventh pixel circuit and an eighth pixel circuit which are sequentially disposed.

16. A display apparatus comprising:
a display panel including a pixel circuit and a sensing circuit, the pixel circuit including a light emitting element, a driving switching element configured to transmit a driving current to the light emitting element, a writing switching element configured to apply a data voltage to the driving switching element in response to a writing gate signal, and the sensing circuit including a first sensing switching element including a first sensing switching element first electrode configured to receive a first power voltage and a first sensing switching element second electrode connected to a fourth node and a second sensing switching element including a second sensing switching element control electrode configured to receive the writing gate signal, a second sensing switching element first electrode connected to the fourth node and a second sensing switching element second electrode connected to a readout line;
a gate driver configured to apply a writing gate signal to the pixel circuit and the sensing circuit;
a data driver configured to apply the data voltage to the pixel circuit; and
a sensing driver connected to the readout line.

17. The display apparatus of claim 16, wherein the data driver and the sensing driver are integratedly formed.

18. The display apparatus of claim 16, wherein the sensing driver is configured to apply a monitoring voltage to a control electrode of the first sensing switching element,
wherein the sensing driver is configured to receive a sensed current through a readout line while changing the monitoring voltage, and
wherein the sensing driver or a driving controller is configured to determine temperatures for positions of the display panel based on the sensed current.

19. The display apparatus of claim 18, wherein the driving controller is configured to compensate a data signal based on the temperatures for the positions, and
wherein the data driver is configured to generate the data voltage based on the compensated data signal and to apply the data voltage to the pixel circuit.

20. An electronic apparatus comprising:
a display panel including a pixel circuit and a sensing circuit, the pixel circuit including a light emitting element, a driving switching element configured to transmit a driving current to the light emitting element, a writing switching element configured to apply a data voltage to the driving switching element in response to a writing gate signal, and the sensing circuit including a first sensing switching element including a first sensing switching element first electrode configured to receive a first power voltage and a first sensing switching element second electrode connected to a fourth node and a second sensing switching element including a second sensing switching element control electrode configured to receive the writing gate signal, a second sensing switching element first electrode connected to the fourth node and a second sensing switching element second electrode connected to a readout line;
a gate driver configured to apply a writing gate signal to the pixel circuit and the sensing circuit;
a data driver configured to apply the data voltage to the pixel circuit;
a driving controller configured to control the gate driver and the data driver; and
a processor configured to output input image data and an input control signal to the driving controller.
